(19) United States
(12) Patent Application Publication
(10) Pub. No.: US 2019/0212993 A1
(43) Pub. Date: Jul. 11, 2019

(54) Compressed Instruction Code Storage

(71) Applicant: Synopsys, Inc., Mountain View, CA (US)

(72) Inventor: Marcus J. Mauro, Felton, CA (US)

(21) Appl. No.: 16/193,871

(22) Filed: Nov. 16, 2018

Related U.S. Application Data
(63) Continuation of application No. 13/654,482, filed on Oct. 18, 2012, now abandoned.

(51) Int. Cl. G06F 8/41; G06F 9/30

(52) U.S. Cl. CPC G06F 8/4434; G06F 9/30178

(57) ABSTRACT

Computer implemented techniques are disclosed for identification of repeated binary strings and for storing those binary strings in order to compress code. The binary strings can be longer instructions, data, or addresses. A table of binary strings is generated based on repeated occurrences, and a reference index is provided for accessing specific entries within the table. An opcode uses a shorter string as an index through which to access the table. The longer string is executed when the longer string is an instruction. When the longer string is an address or data, the appropriate address or data arc accessed.

### FIELD OF ART

This application relates generally to data manipulation and more particularly to compressed instruction code storage.

### BACKGROUND

A variety of methods arc employed to implement state-of-the-art electronic systems. Systems designers must routinely make significant tradeoffs during the design process to balance system performance, physical size, architectural complexity, power consumption, heat dissipation, fabrication complexity, cost, and other design criteria. Each design decision exercises a profound influence on the resulting electronic systems designs. The electronic system may be custom designed (or purpose-built), or be based on application-specific integrated circuits (ASIC), field programmable gate arrays (FPGA), consumer off-the-shelf (COTS) components, or microprocessors. A custom designed system is routinely constructed from a variety of circuits including digital, analog, and even high frequency components, depending on system requirements. Designers choose to construct custom circuits because of feature, architecture, and performance requirements. Such a purpose-built system is exceptionally complex and therefore difficult, expensive, and time consuming to design. Microprocessor-based implementations may lack particular system capabilities or the same high levels of performance achievable by the custom designs, but microprocessor-based designs do offer the advantage of being based on general-purpose hardware and being programmable. Microprocessor-based designs are modified through programming to later implement particular system requirements. In addition to rapid initial design, these implemented requirements further offer the flexibility of system modification or upgrade by allowing the reprogramming of the microprocessor.

Microprocessor-based systems can be deployed as embedded systems. Embedded systems are specially designed computer systems which perform control and other functions within larger systems which require real-time computing. Today, thousands of common items include embedded systems, including major and minor household appliances, vehicles, vehicle keys, tools, toys, safety equipment, and audio/video equipment, to name only a few. Other common items, such as communications equipment (including digital radios and cellular telephones), broadcasting equipment, and video systems for broadcast or surveillance applications all rely on inexpensive, powerful microcomputers. While non-programmable solutions may be possible in many of these applications, the resulting systems are cumbersome, inflexible, and expensive and are thus only used when other solutions are not feasible. Microprocessor-based systems may be easily and flexibly programmed to meet the requirements of the embedded systems using various types of programming code.

### SUMMARY

Techniques implemented to improve the density of application code in embedded systems are used to identify repeated instances of long instructions in the code and to efficiently store and reference these long instructions. In addition, identification and index creation for large data sections and long addresses may similarly improve storage density. A computer-implemented method for data manipulation is disclosed comprising: obtaining a table of binary strings wherein the binary strings are referenced using shorter strings; storing the table of binary strings to binary string storage; and accessing, based on an opcode, a binary string from the binary strings from the binary string storage when the binary string is referenced using a shorter string.

The accessing may be accomplished in one instruction step. The binary string may include an instruction. The instruction may include a four, six, or eight byte instruction. The method may further comprise emitting an instruction to cause a larger instruction to be executed. The binary string may include one of large data or a long address. The large data or the long address may include four, six, or eight bytes. The method may further comprise emitting an index to cause a large constant and/or long address to be retrieved. The opcode may include a special purpose instruction. The opcode and the shorter string may comprise a minimum size instruction for an architecture. The binary string may be referenced using two bytes. The binary string may be longer than two bytes. Binary string storage may comprise one or more binary string storages. The binary string storage may access another binary string storage unit.

In embodiments, an apparatus for data manipulation may comprise: a processor on a semiconductor chip; a special purpose table on the semiconductor chip wherein the special purpose table stores a table of binary strings wherein the binary strings are referenced by an index; and an opcode, for the processor, which accesses the special purpose table and based on the index accesses a binary string in the special purpose table. In some embodiments, a computer-implemented method for data manipulation may comprise: obtaining code; identifying, within the code, a binary string which is accessed a plurality of times; generating a table including the binary string; and substituting, in place of the binary string, a shorter binary string based on where in the table the binary string resides. The method may further comprise evaluating an object file to identify most commonly used data or addresses and placing most commonly used values into the table. The most commonly used data or addresses identified may include large data or long addresses. The method may further comprise modifying a compiler or linker to facilitate the identifying of the binary string. The method may further comprise recompiling the code to put the binary string into the table. The table may be placed into binary string storage. The method may further comprise evaluating an object file to identify most commonly used instructions and placing the most commonly used instructions into the table. The most commonly used instructions may be identified include large instructions. The binary string may be populated into binary string storage by a compiler or linker. The substituting may reduce code size. The code may include an application-specific code comprising object modules and libraries and wherein the identifying analyzes for repeated large binary strings comprising large instructions; wherein the binary strings comprising long instructions are stored in binary string storage; and wherein a compiler is enhanced to access the binary string storage and wherein the compiler stores the long instructions in the binary string storage and emits instructions to access the long instructions within the binary string storage.

In embodiments, a computer system for code compression may comprise: a memory which stores instructions; one or more processors coupled to the memory wherein the one or more processors are configured to: obtaining code; identifying, within the code, a binary string which is accessed a plurality of times; generating a table including the binary string; and substituting, in place of the binary string, a shorter binary string based on where in the table the binary string resides. In some embodiments, a computer program product embodied in a non-transitory computer readable medium for code compression may comprise: code for obtaining code; code for identifying, within the code, a binary string which is accessed a plurality of times; code for generating a table including the binary string; and code for substituting, in place of the binary string, a shorter binary string based on where in the table the binary string resides

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for compressed instruction code access.

FIG. 2 is a flow diagram for compressed instruction code storage.

FIG. 3 is a flow diagram for analysis tool usage/modification.

FIG. 4 is an example table of execute indexed instructions.

FIG. 5 is an example table of load-indexed data and addresses.

FIG. 6 is an example showing program counter interaction.

FIG. 7 is a system diagram for code analysis and data manipulation.

FIG. 8 is a system diagram for string table usage.

### DETAILED DESCRIPTION

Microprocessors are routinely deployed in embedded systems. Embedded systems are specially designed computer systems which perform control and other functions within larger systems which require real-time computing. These systems have become ubiquitous, finding applications in appliances, automobiles, aircraft, heavy equipment, electronics, communications systems, and a myriad of other applications and products. Embedded systems provide excellent design and implementation flexibility at a relatively low cost.

Embedded systems have access to typical microprocessor components such as ALUs, control logic, multiple cores, multiple threads, caches, memory management, floating point capabilities, GPUs, and various buses and interfaces. Such systems are optimized as much as possible to reduce size, cost, power consumption, heat dissipation, and a variety of other parameters. In order to facilitate this optimization, various components may be deleted from a given microprocessor. One critical optimization goal is the maximum possible reduction of application code size. To some extent, code size may be reduced through various programming techniques, such as strategic choices of algorithms, heuristics, and libraries. Ultimately, however, the size of the application code is based on the ability of a compiler, linker or other tool to efficiently produce executable code and to take advantage of the hardware capabilities of the microprocessor.

In the disclosed concept, the size of application code stored and executed by an embedded microprocessor is reduced. Application code is analyzed and long strings which arc accessed more than once globally throughout the code arc identified. A table is generated comprising strings representing long instructions, large data, or long addresses. The string table is then stored in string table storage. The long strings are accessed using an index. A shorter string can be used in place of the longer string; in embodiments, the shorter string is based on an added or modified opcode, and provides an index indicating where in the table the longer string resides. Long strings need be stored only once, after which they may be referenced using a shorter string as often as the application code requires.

Application and data storage efficiency is critical to embedded computer systems, systems where instruction and data stores are limited. Code which executes on the embedded microprocessor is comprised of instructions, data, addresses, and the like. Long instructions, large data, and long addresses may require several bytes each to be stored in instruction and data memories, while other instructions, data, and addresses may only require a relatively minimal amount of storage. An embedded microprocessor architecture dictates the minimum instruction, data, and address sizes. Depending on a given code, a plurality of long instructions, large data, and long addresses may recur a plurality of times throughout the code. It is inefficient to store each occurrence of a long instruction, large data, and long address, since this means identical information is stored multiple times. A table of binary strings comprising long instructions, large data, and long addresses is obtained. The binary strings are referenced using shorter strings. The table of binary strings is written to binary string storage. Based on an opcode, one of the binary strings from the binary string storage is accessed when the binary string is referenced through one of the shorter strings.

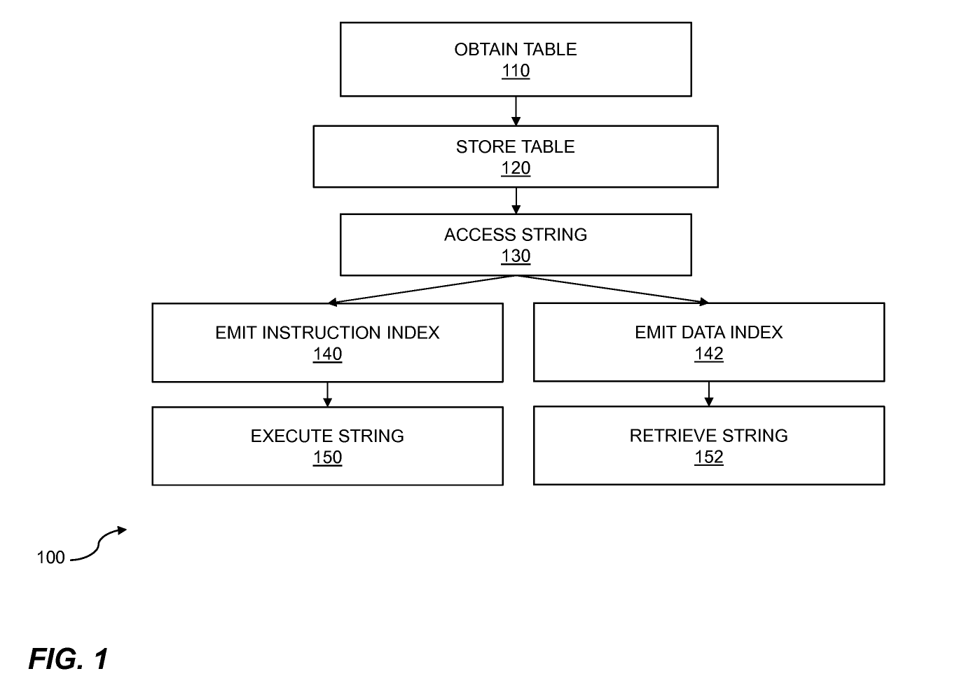

FIG. 1 is a flow diagram for compressed instruction code access. A flow 100 for usage of compressed binary strings is described. The flow 100 includes obtaining a table 110 of binary strings wherein the binary strings are referenced using shorter strings. The table of strings may result from analysis of a code to identify long instructions, large data, and long addresses. An analysis tool used to identify such long binary strings may constitute a compiler, a modified compiler, a linker, a modified linker, a custom analysis tool, and the like.

The flow 100 includes storing the table 120 of binary strings to binary string storage. The storage may be any memory useful for retaining binary information. Binary string storage may comprise one or more binary string storage units. In embodiments, the one or more string storages can be special purpose memories available to an embedded computer, while in other embodiments, the one or more string storages can be general-purpose memories available to an embedded computer. The binary string storage units may be used independently; different units (or memories or portions of memories) may be used to store instructions, data, or addresses. A string storage unit may access another binary string storage unit.

The flow 100 continues with accessing, based on an opcode, one of the binary strings 130 from the binary string storage when the binary string is referenced using one of the shorter strings. The opcode may be an added opcode or a modified or repurposed opcode. The binary string may be referenced using two bytes. The opcode may comprise an index for referencing a binary string contained in binary string storage. The binary string may include a large instruction, or one of a large data or a long address. The binary string may be longer than two bytes. For example, the instruction represented by the binary string may include a three, four, six, or eight byte instruction. Other instruction sizes are possible, and the sizes are dependent on the particular embedded computer. In embodiments, the accessing is accomplished in one instruction step.

The flow 100 may include emitting an instruction index 140 in order to cause the execution of a larger instruction. When a shorter string is encountered in the code, the special purpose instruction references a longer instruction stored in a binary string table. In this manner, the opcode of the shorter string drives access to the instruction represented by the longer string. The opcode and the shorter string may comprise a minimum size instruction for an architecture. In some cases, the opcode and the shorter string may comprise two bytes. The flow 100 may include executing string 150. When an instruction index is emitted 140 and a string representing a long instruction is retrieved, the instruction represented by the long string is executed.

The flow 100 may include emitting a data or address index 142 to cause the retrieval of a large constant and/or a long address. In this case, the shorter string references larger data or a longer address stored in a binary string table. The opcode of the shorter string may cause access to the large data or long address represented by the shorter string. The flow 100 may continue with retrieving a string 152. When a data or address index is emitted 142 and a short string standing in for large data or a long address is accessed, the corresponding long string is retrieved 152. The retrieved long string may then be used as data, or may be used as a long address, depending on the embodiment. Various steps in the flow 100 may be changed in order, repeated, omitted, or the like without departing from the disclosed inventive concepts. Various embodiments of the flow 100 may be included in a computer program product that includes code executable by one or more processors embodied in a non-transitory computer readable medium.

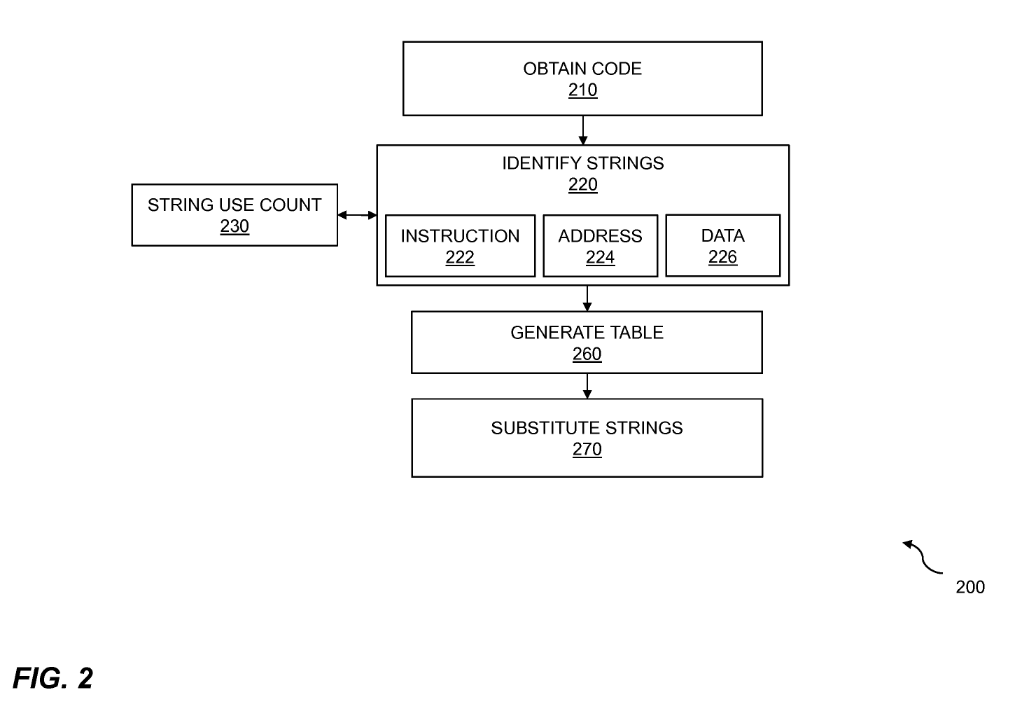

FIG. 2 is a flow diagram for compressed instruction code storage. A flow 200 may continue from or be part of a previous flow 100. In some embodiments, the flow 200 may stand on its own and work from pre-existing binary string tables or other tables. The flow 200 includes obtaining code 210. The code may include an application-specific code comprising object modules and libraries, or the code may include other appropriate codes. In embodiments, the code may already be stored in memory. The flow 200 may include identifying within the code a binary string 220 which is accessed a plurality of times. In embodiments, the identifying may analyze for any large binary string. For example, the identifying may analyze for repeated large binary strings comprising large instructions 222. Similarly, the identifying may analyze for repeated large binary strings comprising addresses 224 and data 226. The most commonly used instructions 222 identified within the code may include large instructions; thus a binary string may comprise an instruction 222 which is longer than the minimum sized instruction. Similarly, the most commonly used data or addresses identified may include large data or long addresses; so a binary string may comprise a long address 224 or a large data 226. In each case, the string may be longer than a minimum sized instruction, address, or data. The code which is examined may be source code, application code, object code, or other code appropriate to the area of art. The flow 200 may continue with generating a string usage count 230. Strings which may be identified to be accessed a plurality of times may be prioritized based on the number of times the strings are accessed throughout the code. For example, a string which is accessed more times than another string may be granted a higher priority than the latter string. The flow 200 continues with generating a table 260 including the binary string. Any string identified may be placed into a table of binary strings. For example, the binary strings comprising long instructions may be stored in binary string storage. Similarly, any binary strings comprising long addresses or large data may be stored in binary string storage. The most commonly accessed instructions, addresses, and data identified by evaluating an object file may be placed into a table. That is, the flow 200 may further comprise evaluating an object file to identify the most commonly used data or addresses and placing the most commonly used instructions into the table 260. In embodiments, there may be more than one table for storing strings. In further embodiments, “tables of strings” may refer to one table or a plurality of tables of strings. The table or tables may be placed into binary string storage. In embodiments, binary string storage may be a special purpose memory or a general-purpose memory. The binary string may be populated into binary string storage by a compiler. The flow 200 may continue with substituting, in place of the binary string, a shorter binary string 270 based on where in the table the binary string resides. The shorter string may be substituted into source code, an object module, or other code. The substituting may reduce code size. For example, a shorter instruction may be substituted for a longer instruction and may reference the longer instruction while the longer instruction is stored in a string table. Similarly, a shorter address or data may be substituted for a longer address or data and may reference the longer address or data while the longer address or data is stored in a string table. A compiler may be enhanced to access the binary string storage. A linker or pre-linker may be enhanced to access the binary string storage. The compiler may store the long instructions in the binary storage and emit instructions to access the long instructions within the binary storage. A linker or pre-linker may modify object code in order to store the long instructions in the binary storage and emit instructions to access the long instructions within the binary storage. Various steps in the flow 200 may be changed in order, repeated, omitted, or the like without departing from the disclosed inventive concepts. Various embodiments of the flow 200 may be included in a computer program product embodied in a non-transitory computer readable medium that includes code executable by one or more processors.

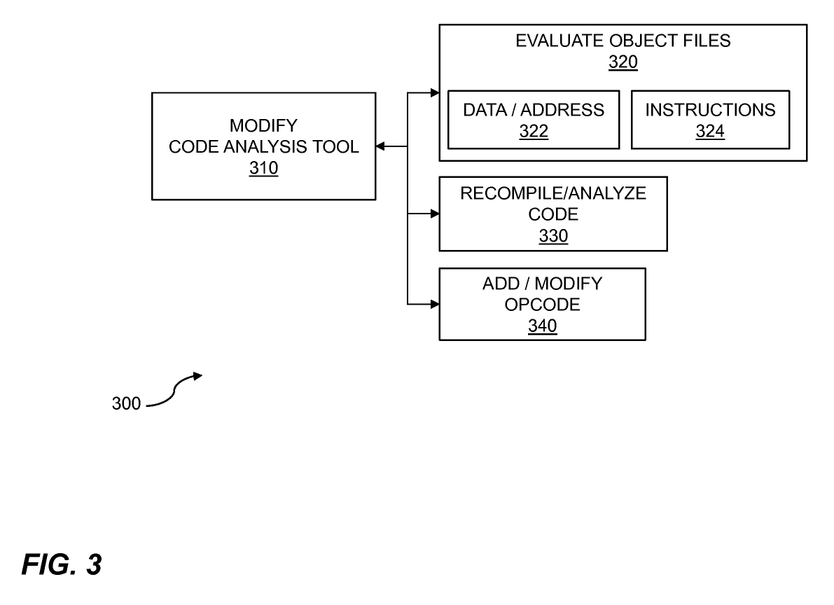

FIG. 3 is a flow diagram for analysis tool usage/modification. A flow 300 may continue from or be part of a previous flow 100. In some embodiments, the flow 300 may stand on its own and work from pre-existing object files or other files. A flow 300 includes evaluating an object file 320 to identify the most commonly used instructions 324 and placing the most commonly used instructions into the table. A flow 300 may further comprise evaluating an object file to identify the most commonly accessed data and addresses 322 and placing the most commonly used data and addresses into the table. The flow 300 may continue with adding an opcode to an instruction set or with modifying or repurposing an existing opcode 340. The adding an opcode may comprise defining a previously unused opcode for table access. The modifying or repurposing an opcode may comprise using a previously defined opcode for table access. The flow 300 may continue with modifying a code analysis tool 310 to facilitate identifying of binary strings, to use added or modified opcodes, and to access binary string storage. A code analysis tool may comprise a compiler, a linker, a pre-linker, or other analysis tool. In embodiments, the flow 300 may further comprise modifying a compiler to facilitate the identifying of the binary string. In other embodiments, the flow 300 may further comprise modifying a linker or pre-linker to facilitate the identifying of the binary string. The flow 300 may continue with recompiling or analyzing the code 330 to put the binary string into the table. The recompiling may add or substitute an opcode which includes a special purpose instruction. For example, the opcode may include an index which may be used to access an element of binary string storage. Various steps in the flow 300 may be changed in order, repeated, omitted, or the like without departing from the disclosed inventive concepts. Various embodiments of the flow 300 may be included in a computer program product embodied in a non-transitory computer readable medium that includes code executable by one or more processors.

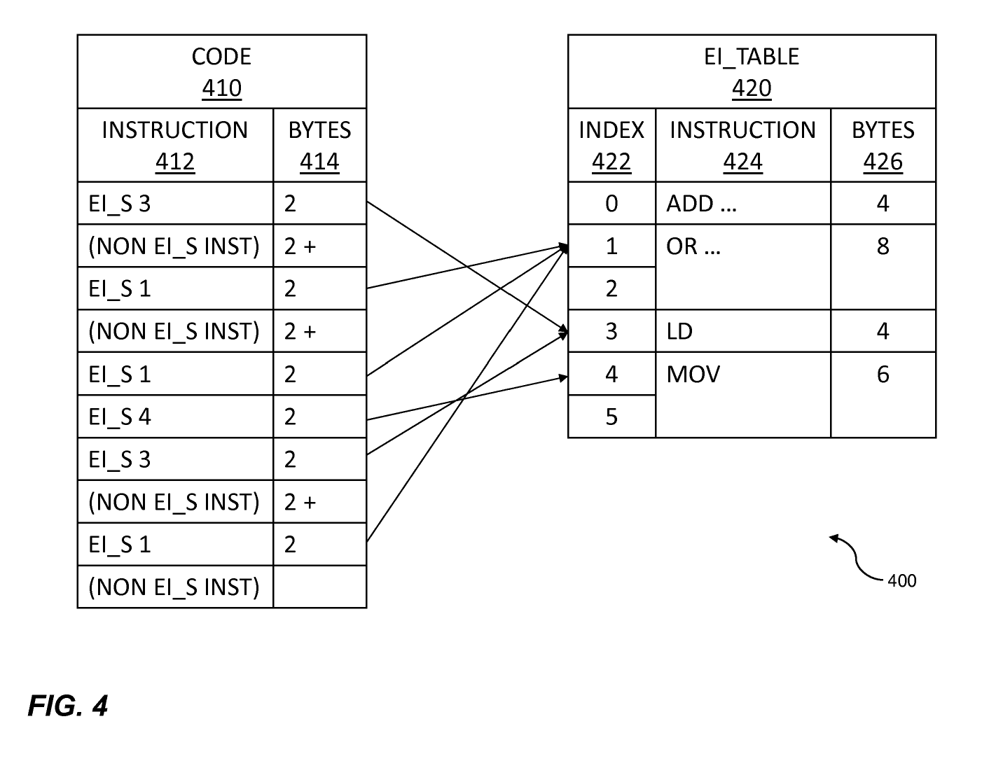

FIG. 4 is an example table of execute-indexed instructions 400. Code 410 may be obtained and analyzed for binary strings which are accessed a plurality of times. The binary string may include an instruction which may comprise more bytes than the minimum instruction size allowed for a given processor. For example, the instruction may include a four, six, or eight byte instruction, while the minimum supported instruction size is two bytes. For other processor architectures, other instruction sizes may be supported. From analysis for binary strings, a table may be generated. The analysis of a given piece of code may identify a plurality of instructions which are accessed a plurality of times. Those instructions may then stored in an execute index (EI) table 420. Each instruction 424 comprises a number of bytes 426 greater than the minimum size for an instruction. Further, each instruction is assigned an index 422 which allows access to the long instruction 424 within the EI Table 420. To access the instructions 424 in the EI Table 420, the code 410 is rewritten to include EI instructions 412 and other non-EI instructions. The byte count 414 for each instruction 412 in code 410 is shown. As code 410 is executed, each instruction 412 is executed in turn. In the case of a non-EI instruction, the instruction is simply executed. In the case of an EI instruction, a short instruction including an index may be emitted and cause a larger instruction in the EI Table 420 to be executed. Examining instructions 412 shows that several, longer, instructions occur two or more times. So, each time a given EI_S instruction is encountered, a shorter instruction is emitted which causes the longer instruction 424 in the EI Table 420 to be executed. For example, each occurrence of EI_S 3 causes the instruction 424 located at index 422 value 3 to be executed. The result of use of the EI Table 420 is that longer instructions that occur two or more times are stored only once in the EI Table 420, and referenced by emitting a shorter instruction 412 in the code 410.

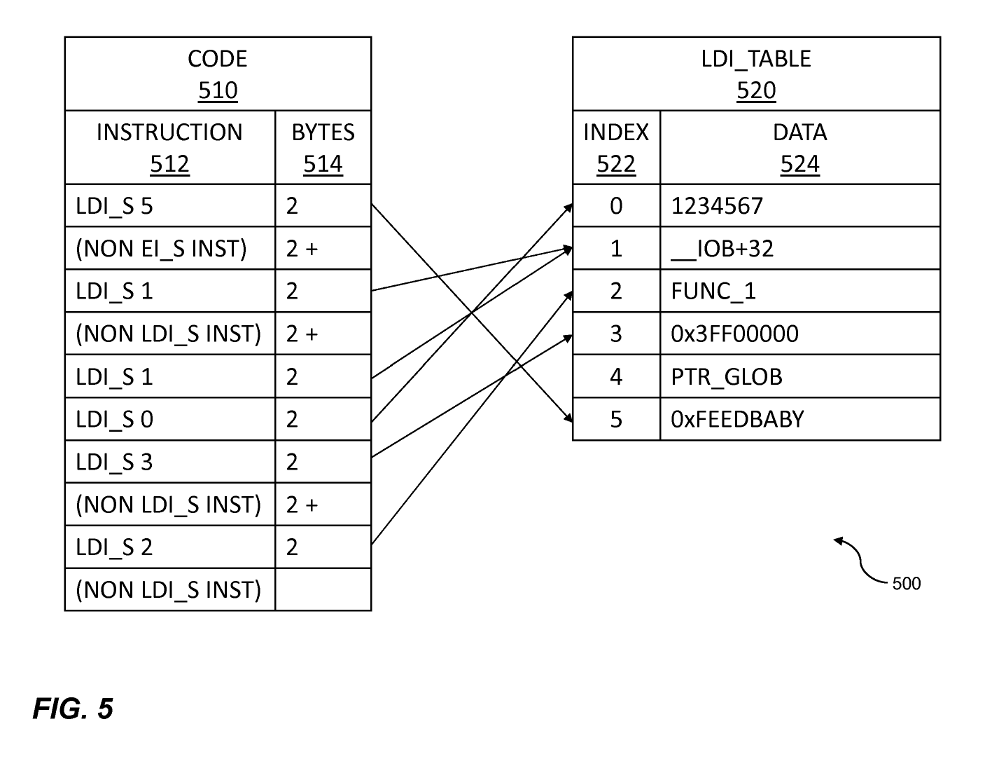

FIG. 5 is an example table of load-indexed data and addresses 500. Code 510 may be obtained and analyzed for binary strings which are accessed a plurality of times throughout the code. The binary string may include one of large data or a long address, and the data or address may comprise more bytes than the minimum data or address size allowed for a given processor. For example, the large data or long address may include a four, six, or eight bytes, while the minimum data or address size supported is just two bytes. For other processors, other data and address sizes may be supported. From that analysis, a table may be generated. For example, the analysis of a given piece of code may identify a plurality of data and addresses which are accessed a plurality of times. Those data and addresses may then be stored in a load index table 520. Each data or address 524 comprises a number of bytes greater than the minimum size for data or addresses. Further, each data and address is assigned an index 522 which allows access to the long data or address 524 within the LD Table 520. To access the data and addresses 524 in the LD Table 520, the code 512 is rewritten to include LDI instructions 512 and other non-LDI instructions. The byte count 514 for each instruction 512 in code 510 is shown. As code 510 is executed, each instruction 512 is obtained and executed. The example 500 may comprise emitting an index to cause a large constant and/or long address to be retrieved. In the case of a non-LDI instruction, the instruction is simply executed. In the case of an LDI instruction, a short instruction including an index may be emitted to cause a larger data or longer address in the LDI Table 520 to be retrieved. Examining instructions 512 yields that several, longer data and addresses occur two or more times. So, each time a given LDI_S instruction is encountered, a shorter instruction is emitted and causes the retrieval of the larger data or longer address 524 in the LDI Table 520. For example, each occurrence of LDI_S 1 causes the larger data or longer address located at index 522 value 1 to be retrieved. The result of use of the LDI Table 220 is that longer data and addresses that occur two more times are stored only once in the LDI Table 520; they are referenced by emitting a shorter reference 512 in the code 510.

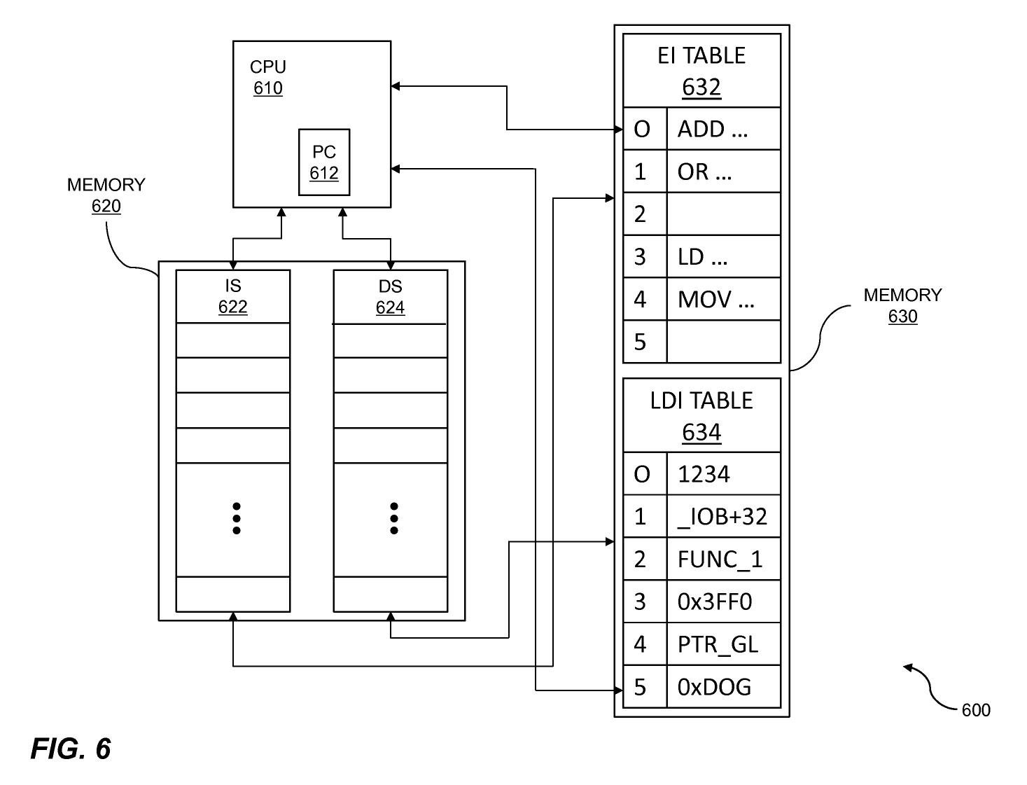

FIG. 6 is an example block diagram showing program counter interaction. The example 600 shows an embedded system which comprises a central processing unit (CPU) 610, a program counter (PC) 612, a memory 620 including an instruction store (IS) 622 and a data store (DS) 624, and a memory 630 including an execute indexed (EI) table 632 and a load indexed (LDI) table 634. The memory 630 may store a table or multiple tables of binary strings. The binary strings stored in 630 may include instructions and may include large data or long addresses. In the example, the IS 622 has access to EI Table 632 and the DS 624 has access to LDI Table 634. The CPU 610 may execute instructions from the IS 622 and may operate upon data in the DS 624. The PC 612 indicates which instruction in the IS 622 to execute. Each instruction includes an opcode which may include a special purpose instruction. In the example 600, long instructions which occur a multiplicity of times have been identified and stored in EI Table 632. Example instructions are shown in the EI table 632. Similarly, data and addresses which occur a multiplicity of times have been identified and stored in LDI Table 634. Again, example data and addresses are shown in the table 634. Further, shorter opcodes which may refer to longer instructions are stored in the IS 622, and shorter indexes which refer to larger data and longer addresses are stored in DS 624. The instruction pointed to by the PC 612 may refer to an instruction in the EI Table 632. Thus, executing the instruction pointed to by the PC 612 may comprise emitting an instruction to cause a larger instruction stored in the EI Table 632 to be executed.

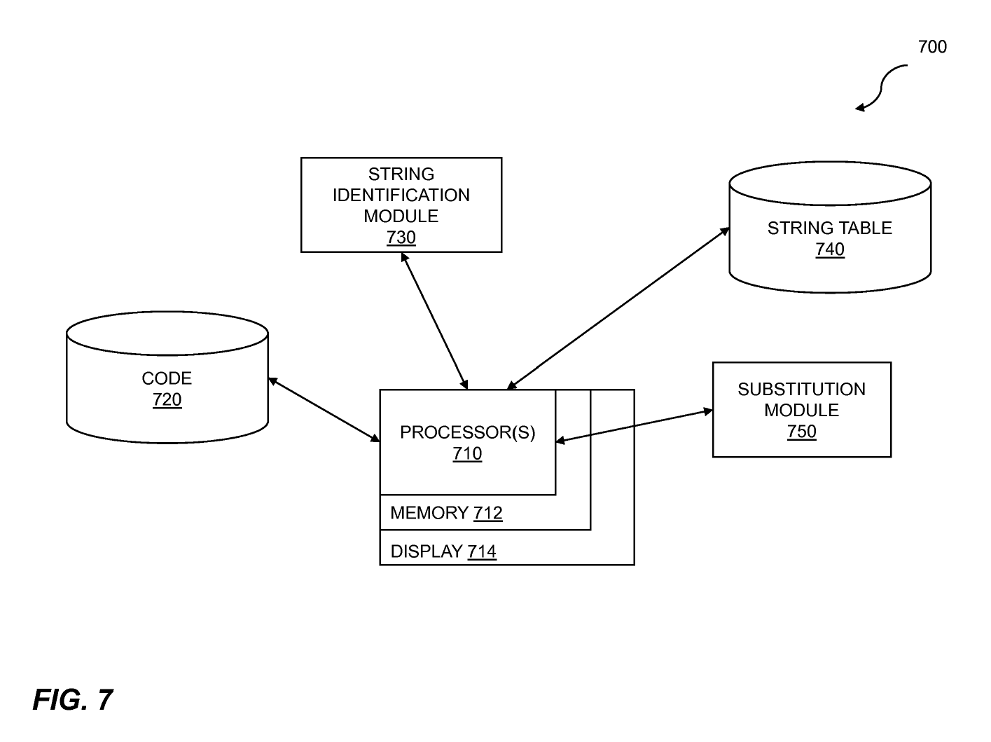

FIG. 7 is a system diagram for code analysis and data manipulation. A system 700 may comprise one or more processors 710 coupled to a memory 712 and a display 714. The one or more processors 710 may be coupled to code storage 720, a string identification module 730, string table storage 740, and a substitution model 750. In at least one embodiment, the one or more processors 710 may accomplish the string identification module 730 and substitution model 750 functions. The one or more processors 710 may access the code storage 720 to obtain code for manipulation. The processors 710 may identify, within the code, a binary string which is accessed a plurality of times. The binary string may be an instruction, an address, or a data. The binary string will be referenced by a shorter binary string. The reference string will be stored in the string table 740. The processors 710 may generate a table including the binary string. The table may include numerous binary strings where the binary strings are accessed a plurality of times. The processors 710 may substitute, in place of the binary string, a shorter binary string based on where in the table the binary string resides. The shorter binary string may provide an index for accessing the longer binary string where the index indicates a position for the longer binary string in the table. In embodiments, the string table 740 is stored in a special-purpose memory, while in other embodiments a general-purpose memory is used. The string table 740 may store instructions. Likewise, the string table 740 may store addresses or data. Multiple string tables are possible for various implementations. The string table 740 is accessed by the one or more processors 710 using an opcode; the opcode may be a special purpose opcode. When the opcode is emitted, the binary string in the string table 740 is accessed and executed, as in the case of an instruction. When the binary string is an address or data, the respective address or data is retrieved using the opcode.

The string identification module 730 may evaluate the code 720 to determine binary strings that are used multiple times. The string identification module 730 may also evaluate those strings which are used most frequently so that those most frequently used strings receive priority for storage in the string table. The string identification module 730 may work in conjunction with a compiler, linker, pre-linker, or a special tool, or may work independently. In the case where the string identification module 730 works with a compiler, the module 730 may use a compiler to substitute shorter instructions in place of longer ones, and may create a string table to store the longer strings. In cases when the string identification module 730 works with a linker, the module 730 may use the linker to perform modification to the code being linked in order to achieve the substitution of shorter strings in place of longer strings and which support string storage. The substitution module 750 may evaluate the code 720 and use results from the string identification to determine shorter strings that are used as references for longer binary strings. These shorter strings are used with an opcode to access the longer strings stored in the string table 740.

The one or more processors 710 may be coupled to the memory 712 which stores code, code analysis, design data, instructions, system support data, intermediate data, analysis results, and the like. The one or more processors 710 may be coupled to an electronic display 714. The display 714 may be any electronic display, including but not limited to, a computer display, a laptop screen, a net-book screen, a tablet computer screen, a cell phone display, a mobile device display, a remote with a display, a television, a projector, or the like.

The system 700 may include a computer program product. The computer program product may comprise code for obtaining code; code for identifying, within the code, a binary string which is accessed a plurality of times; code for generating a table including the binary string; and code for substituting, in place of the binary string, a shorter binary string based on where in the table the binary string resides.

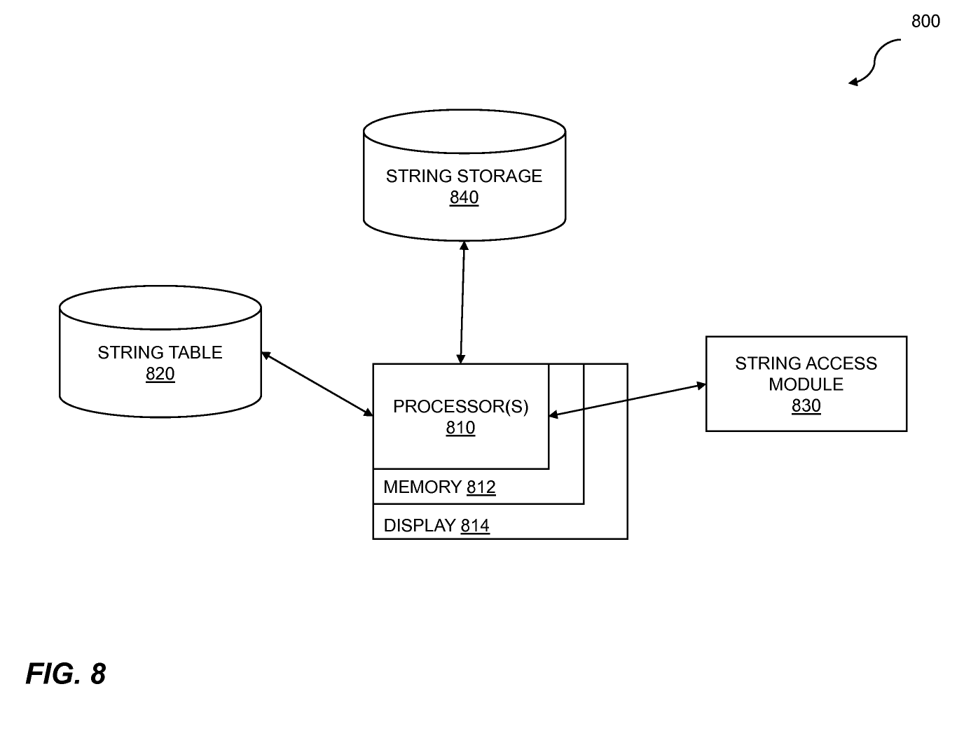

FIG. 8 is a system diagram for string table usage. A system 800 may comprise one or more processors 810 coupled to a memory 812 and a display 814. The one or more processors 810 may be coupled to string table 820, a string access module 830, and string table storage 840. In at least one embodiment, the one or more processors 810 may accomplish the string access module 830 function. The one or more processors 810 may access the string table 820 to obtain a table of binary strings wherein the binary strings are referenced using shorter strings. The processors 810 may store the table of binary strings to binary string storage 840. The binary string may be an instruction, an address, or a data. The binary string will be longer than the string that references the binary string. The processors 810 may access 830, based on an opcode, one of the binary strings from the binary string storage 840 when the binary string is referenced using one of the shorter strings. In embodiments, the string storage 840 is a special-purpose memory while in other embodiments a general-purpose memory is used. The string table storage 840 may store instructions, addresses, or data. Multiple string table storages are possible for various implementations. The string table storage 840 may be accessed by the one or more processors 810 using an opcode; the opcode may be a special purpose opcode. When the opcode is emitted, the binary string in the string table storage 840 is accessed and executed, as in the case of an instruction. When the binary string is an address or a data, the respective address or data is retrieved using the opcode.

The one or more processors 810 may be coupled to the memory 812 which stores code, code analysis, design data, instructions, system support data, intermediate data, analysis results, and the like. The one or more processors 810 may be coupled to an electronic display 814. The display 814 may be any electronic display, including but not limited to, a computer display, a laptop screen, a net-book screen, a tablet computer screen, a cell phone display, a mobile device display, a remote with a display, a television, a projector, or the like.

The system 800 may include an apparatus for data manipulation. The apparatus may comprise a processor on a semiconductor chip; a special purpose table on the semiconductor chip wherein the special purpose table stores a table of binary strings wherein the binary strings arc referenced by an index; and an opcode, for the processor, which accesses the special purpose table and based on the index accesses a binary string in the special purpose memory.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

1. A computer-implemented method for data manipulation comprising:
obtaining a table comprising a plurality of codes from a storage;
analyzing with a analysis tool the plurality of codes;
selecting a plurality of long binary strings from the table, wherein each of the plurality of long binary strings comprises an instruction of a first length;
referencing the plurality of long binary strings with a plurality of short binary strings each having an instruction of a third length shorter than the first length;
storing the plurality of short binary strings in the storage;
accessing, based on an opcode, one of the short binary strings from the storage when the short binary string is referenced by an associated one of the plurality of long binary strings, wherein the opcode is an index associated with one of the short binary strings;
dispatching a first instruction corresponding with the accessed short binary string to reference a second instruction corresponding with the associated long binary string, said second instruction being longer than the first instruction; and
executing the second instruction.

2. The method of claim 1 wherein the accessing is accomplished in one instruction step.

3. The method of claim 1 wherein the upcode associated with the long binary string includes an instruction, a data, or an address.

4. The method of claim 3 wherein the instruction includes a four, six, or eight byte instruction.

5. The method of claim 1, further comprising emitting an instruction to cause a larger instruction to be executed.

6. The method of claim 1 wherein the plurality of codes comprises source code, application codes, or object code.

7. The method of claim 3 wherein the large data or address includes four, six, or eight bytes.

8. The method of claim 1, wherein the analysis tool comprises a compiler, a linker, and a custom analysis device.

9. The method of claim 1 wherein the opcode includes a special purpose instruction.

10. The method of claim 1 wherein the opcode and the shorter binary string comprise a minimum size instruction for an architecture.

11. The method of claim 1 wherein the plurality of long binary strings each is referenced using two bytes.

12. The method of claim 1 wherein one of the short binary strings is longer than two bytes.

13. The method of claim 1 wherein the binary string storage comprises one or more binary string storages.

14. The method of claim 13 wherein the binary string storage accesses another binary string storage.

15. An apparatus for data manipulation comprising:
a processor on a semiconductor chip;
a special purpose table on the semiconductor chip wherein the special purpose table stores a table of binary strings wherein the binary strings are referenced by an index; and
an opcode, for the processor, which accesses the special purpose table and based on the index accesses a binary string in the special purpose table.

16. (canceled)

17. The method of claim 1 further comprising evaluating an object file to identify most commonly used data or addresses and placing most commonly used values into the table.

18. The method of claim 17 wherein the most commonly used data or addresses identified include large data or long addresses.

19. The method of claim 8 further comprising modifying the compiler or the linker to facilitate the identifying of the binary string.

20. The method of claim further comprising recompiling the upcode to put the binary string into the table.

21. The method of claim 1 wherein the table is to be placed into the binary string storage.

22. The method of claim 17 further comprising evaluating an object file to identify most commonly used instructions and placing the most commonly used instructions into the table.

23. The method of claim 22 wherein the most commonly used instructions identified include large instructions.

24. The method of claim 8 wherein the binary string is populated into binary string storage by the compiler or the linker.

25. The method of claim 1 wherein the substituting reduces code size.

26. The method of claim 1 wherein the code includes an application-specific code comprising object modules and libraries and wherein the identifying analyzes for repeated large binary strings comprising large instructions; wherein the binary strings comprising long instructions are stored in binary string storage; and wherein a compiler is enhanced to access the binary string storage and wherein the compiler stores the long instructions in the binary string storage and emits instructions to access the long instructions within the binary string storage.

27. A computer system for code compression comprising:
a memory which stores instructions;
one or more processors coupled to the memory wherein the one or more processors are configured to:
obtaining a table comprising a plurality of codes;
analyzing with a analysis tool the plurality of codes;
selecting a plurality of long binary strings from the table, wherein each of the plurality of long binary strings comprises an instruction of a first length;
referencing the plurality of long binary strings with a plurality of short binary strings each having an instruction of a third length shorter than the first length; and
storing the plurality of short binary strings in a storage.

28. (canceled)
